(19) United States
(12) Patent Application Publication
(10) Pub. No.: US 2012/0292134 A1
(43) Pub. Date: Nov. 22, 2012

(54) ATTACHABLE FORKLIFT APPARATUS

(76) Inventor: Larry Lee Miller, Hereford, AZ (US)

(21) Appl. No.: 13/111,949

(22) Filed: May 19, 2011

(51) Int. Cl. B66F 9/22; B66F 9/12

(52) U.S. Cl. 187/234

(57) ABSTRACT

The present invention is an attachable forklift apparatus that includes a front side with two elongated supports, two front plates and a middle plate, two vertical posts that are attached to the front side elongated supports and a hydraulic cylinder that provides hydraulic power to the apparatus disposed within the apparatus. The apparatus also includes a plurality of hydraulic cylinder hoses that are integral to the hydraulic cylinder and a back side that includes two elongated supports, a center opening and a plurality of forks.

### TECHNICAL FIELD & BACKGROUND

Currently there have been minimal enhancements to improve the transportation of agricultural materials. Individuals who are committed to a career in farming are always looking for innovative items to improve upon the process of farming their land.

The present invention generally relates to a forklift apparatus. More specifically, the invention is an attachable forklift apparatus.

It is an object of the invention to provide an attachable forklift apparatus for supporting typical agricultural duties such as lifting bales of hay.

It is an object of the invention to provide an attachable forklift apparatus that allows users to confidently transport heavy materials in a quick and easy fashion.

What is really needed is an attachable forklift apparatus for supporting typical agricultural duties such as lifting bales of hay that allows users to confidently transport heavy materials in a quick and easy fashion.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a rear perspective view of an attachable forklift apparatus without a back side, in accordance with one embodiment of the present invention.

FIG. 1B illustrates a rear perspective view of an attachable forklift apparatus with a back side, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

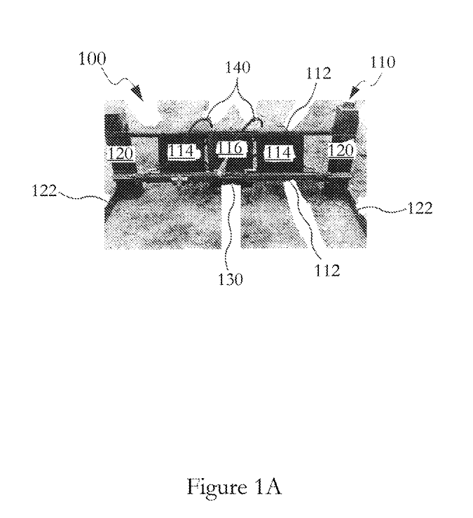

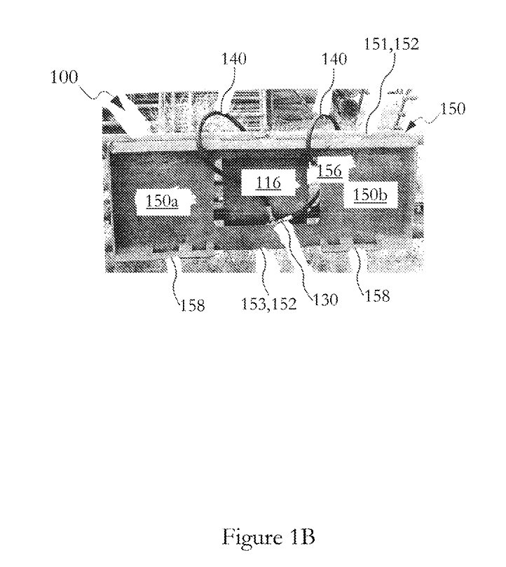

FIG. 1A illustrates a rear perspective view of an attachable forklift apparatus 100 without a back side, in accordance with one embodiment of the present invention. The attachable forklift apparatus 100 includes a front side 110, two vertical posts 120, a hydraulic cylinder 130 and a plurality of hydraulic hoses 140.

The front side 110 includes two elongated supports 112, two front plates 114 and a middle plate 116. The two front plates 114 and the middle plate 116 are attached between the two elongated supports 112 forming the front side 110. The two vertical posts 120 are provided with a horizontal extension 122 along a ground surface GS for added support. The two elongated supports 112 each have two ends that are attached to the two vertical posts 120. The hydraulic cylinder 130 provides hydraulic power to the attachable forklift apparatus 100. The hydraulic hoses 140 are attached to the hydraulic cylinder 130 and provide hydraulic fluid (not shown) to the hydraulic cylinder 130.

FIG. 1B illustrates a rear perspective view of an attachable forklift apparatus 100 with a back side 150, in accordance with one embodiment of the present invention. The back side 150 includes two elongated supports 152, a top overhang 154, a center opening 156 and a plurality of forks 158. The back side 150 is lifted-up utilizing hydraulic power provided by the hydraulic cylinder 130 and hydraulic hoses 152. The back side 150 has a solid planar left side 150a and a solid planar right side 150b. The two elongated supports 152 run across the top 151 and bottom 153 of the back side 150. The top overhang 154 protrudes outwardly away from the top 151 and can be any suitable size. The center opening 156 allows a user to access the hydraulic cylinder 130 and hydraulic hoses 140 and also exposes the middle plate 116 from the back side 150. The forks 158 can be any number of forks, although two forks 158 are displayed in FIG. 1B.

The attachable forklift apparatus is a transporting apparatus that functions to simplify a method of lifting and moving multiple bales of hay or other farm material or supplies. The attachable forklift apparatus is relatively compact in size for easy accessibly into small areas and is able to withstand relatively heavy weighted materials, while lifting them by use of a hydraulic hose and cylinder. Once items are lifted, an accessory tractor enables the attachable forklift apparatus to efficiently carry hay or other material to a designated location in an expeditious matter. The attachable forklift apparatus can easily become an essential tool for independent and commercial farming consumers.

The attachable forklift apparatus serves as a mechanical apparatus for supporting typical agricultural duties. The attachable forklift apparatus with elongated supports allows users to confidently transport heavy materials in a quick and easy fashion.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. An attachable forklift apparatus, comprising:
a front side that includes two elongated supports, two front plates and a middle plate;
two vertical posts that are attached to said front side elongated supports;
a hydraulic cylinder that provides hydraulic power to said apparatus disposed within said apparatus;
a plurality of hydraulic cylinder hoses that are integral to said hydraulic cylinder; and
a back side that includes two elongated supports, a center opening and a plurality of forks and said back side is attached to said front side.

2. The apparatus according to claim 1, wherein said vertical posts are provided with a horizontal extension on each vertical post that runs along a ground surface to provide added support.

3. The apparatus according to claim 1, wherein said back side includes a solid planar left side and a solid planar right side.

4. The apparatus according to claim 1, wherein said back side has 2 forks.

5. The apparatus according to claim 1, wherein said apparatus lifts and carries farm related material or supplies,

6. The apparatus according to claim 1, wherein said apparatus lifts and carries bales of hay.

7. An attachable forklift apparatus, comprising:
a front side that includes two elongated supports, two front plates and a middle plate;
two vertical posts that are attached to said front side elongated supports;
a hydraulic cylinder that provides hydraulic power to said apparatus disposed within said apparatus;
a plurality of hydraulic cylinder hoses that are integral to said hydraulic cylinder; and
a back side that includes two elongated supports, a center opening and a plurality of forks and said back side is attached to said front side.

8. The apparatus according to claim 6, wherein said vertical posts are provided with a horizontal extension on each vertical post that runs along a ground surface to provide added support.

9. The apparatus according to claim 6, wherein said back side includes a solid planar left side and a solid planar right side.

10. The apparatus according to claim 6, wherein said back side has 2 forks.

11. The apparatus according to claim 6, wherein said back side includes a top overhang.

12. The apparatus according to claim 6, wherein said apparatus lifts and carries farm related material or supplies.

13. The apparatus according to claim 6, wherein said apparatus lifts and carries bales of hay.

14. An attachable forklift apparatus comprising:
a front side that includes two elongated supports, two front plates and a middle plate;
two vertical posts that are attached to said front side elongated supports;
a hydraulic cylinder that provides hydraulic power to said apparatus disposed within said apparatus;
a plurality of hydraulic cylinder hoses that are integral to said hydraulic cylinder; and
a back side that includes two elongated supports, a center opening and a plurality of forks and said back side is attached to said front side.

15. The apparatus according to claim 14, wherein said vertical posts are provided with a horizontal extension on each vertical post that runs along a ground surface to provide added support.

16. The apparatus according to claim 14, wherein said back side includes a solid planar left side and a solid planar right side.

17. The apparatus according to claim 14, wherein said back side has 2 forks.

18. The apparatus according to claim 14, wherein said back side includes a top overhang.

19. The apparatus according to claim 14, wherein said back side is approximately 47 inches by 19 inches.

20. The apparatus according to claim 14, wherein said apparatus lifts and carries farm related material, supplies or bales of hay.
